(19) United States
(12) Patent Application Publication
(10) Pub. No.: US 2021/0041246 A1
(43) Pub. Date: Feb. 11, 2021

(54) METHOD AND SYSTEM FOR INTELLIGENT AND ADAPTIVE INDOOR NAVIGATION FOR USERS WITH SINGLE OR MULTIPLE DISABILITIES

(71) Applicant: Ani Dave Kukreja, Dubai (AE)

(72) Inventor: Ani Dave Kukreja, Dubai (AE)

(21) Appl. No.: 16/989,296

(22) Filed: Aug. 10, 2020

Related U.S. Application Data
(60) Provisional application No. 62/884,282, filed on Aug. 8, 2019.

(51) Int. Cl. G01C 21/20; H04M 1/725; H04W 4/024; H04W 4/12; H04W 4/33; G06Q 30/02; G06N 3/08

(52) U.S. Cl. CPC G01C 21/206; H04M 1/72588; H04W 4/024; H04M 2250/10; H04W 4/33; G06Q 30/0282; G06N 3/08; H04W 4/12

(57) ABSTRACT

There is disclosed as Artificial Intelligence, Global Positioning System (GPS), Bluetooth Information Nodes and Augmented Reality based Navigation system for people with multiple disabilities. This system integrates with any enterprise platform to deliver an indoor navigation solution that communicates and learns user responses and requirement patterns, identifies real-time indoor location of a user and guides the user through the optimal path using a control device to an intended destination. This system connects multiple indoor locations through a unified communication path and adapts based on user's real-time needs to provide indoor navigation guidance that helps people with multiple disabilities navigate independently. Data signals are achieved through multiple data sources on a real-time basis. User interface is available as VUI (Voice User Interface), GUI (Graphic User Interface) for all user groups and AUI (Adaptive User interface) driven by Artificial Intelligence (AI) to personalize the User Interface (UI) for people with multiple disabilities.

### CROSS-REFERENCE TO RELATED APPLICATIONS AND PRIORITY

This patent application claims priority from U.S. Provisional Patent Application No. 62/884,282 filed Aug. 8, 2019. This patent application is herein incorporated by reference in its entirety.

### FIELD OF THE INVENTION

The present invention relates to the field of indoor navigation, and more particularly to an intelligent indoor navigation system with a user interface adaptable for a user with one or multiple disabilities.

### BACKGROUND OF THE INVENTION

People suffering from multiple disabilities including deaf, mute, visually impaired, blind, autistic, people with cerebral palsy and other cognitive disorders find it difficult to navigate with independence in indoor public areas such as public transport, malls, hospitals, airports, etc. Ability to comprehend and process information is a great challenge amongst people with cognitive disorders. Whereas, the visual or auditory impairments lead to inability to see or hear guidance to navigate within a closed environment.

Aid systems for the visually impaired or blind people are known in prior art. People suffering from multiple disabilities including: deaf, mute, visually impaired, blind, autistic, those with cerebral palsy and other cognitive disorders find it difficult to navigate with independence in public areas such as: public transport, malls, hospitals, airports, etc.). Ability to comprehend and process information is greatly affected amongst those with cognitive disorders. Whereas, the visual or auditory impairments lead to inability to see or hear guidance to navigate within a closed environment. Studying the social behavior of those with disabilities, it has been found that they have a deep desire to be independent and move around on their own.

Aided indoor wayfinding encompasses all of the ways in which people orient themselves in physical space and navigate from place to place. When there is a well-designed and aided indoor wayfinding system, people are able to understand their environment. This provides users with a sense of control and reduces anxiety, fear and stress. Indoor wayfinding can be particularly challenging for some people with disabilities for example: someone who is deaf or hard of hearing will rely on visual information but may not be able to hear someone providing directions.

Someone who is blind will not be able to see a directory, but if it is in a predictable location and has information in a tactile format, they can read it and they will use sound and even smell to gather more information about their environment. It is important to provide aided indoor wayfinding information in a variety of different formats as visual, auditory and physical to cater to the needs of those with multiple disabilities. People mostly use different forms of information gathering to find their way to their destination but this is especially important for people with disabilities.

For example, Canadian patent CA 2739555 provides for a portable device, similar to the white cane usually used by blind people when equipped with a GPS system. The cane can help them navigate. However, users solely rely on the movement of the cane to be able to detect obstacles and path guidance. This method is found to be less accurate and dependent on the cane movement.

Another traditional known navigation system is disclosed in the U.S. Pat. No. 10,302,757 B2, suggesting an aid system and method for visually impaired users. Accordingly, a user is provided with a control device to identify the object to determine the path, which is sent to the user. This solution does offer guidance to the blind people and people with visual impairment. However, users with other disabilities such as deaf, mute, autistic as well as people with cerebral palsy and other cognitive disorder, cannot be guided properly with the aid system and method described in the prior art. Further, in this solution, the system and method for the visually impaired users were limited to one indoor location.

However, none of the traditional methods disclose a navigation system which is customized based on the particular type of disability of a user or a navigation system adapted for multiple disabilities.

The above information is presented as background information only to assist with an understanding of the present disclosure. No determination has been made, and no assertion is made, as to whether any of the above might be applicable as prior art with regard to the present disclosure.

### SUMMARY OF THE INVENTION

Therefore it is an objective of the present invention to provide a navigation method and system for disabled persons that incorporates an Artificial Intelligence (AI) model with high accuracy, personalized real-time guidance and providing for an enhanced user experience.

The present invention involves an adaptive indoor navigation system for users with single or multiple disabilities comprising an adaptive user interface having a plurality of guidance modes, wherein a particular guidance mode is activated based on selection of a type of user interface by a user of the adaptive indoor navigation system, and wherein the adaptive indoor navigation system is customized based on a type of the disability.

In an embodiment of the present invention, the plurality of guidance modes comprise a text-based guidance mode, voice-based guidance mode and an adaptive user interface which is a combination of text and voice based guidance mode.

In another embodiment, the adaptive indoor navigation system functions based on artificial Intelligence (AI) and Augmented Reality (AR) technologies.

In another embodiment, the user is provided guidance or navigation control through Global Positioning System (GPS) or a multiple-node indoor positioning system.

In another embodiment, an Indoor Web Facility Manager Application is used for real-time path planning.

In another embodiment, crowds and incidents are tracked for the real-time path planning.

In another embodiment, the Indoor Web Facility Manager application further comprises an Information Management module that triggers important alerts and notifications on a user's control device in case of emergency or urgent announcement.

In another embodiment, the system is operable online or offline.

In another embodiment, preplanning of a journey is conducted using pre-defined paths stored in a random access memory (RAM) of a device on which the indoor navigation system is running.

In another embodiment, real time sentiment and personality analysis is conducted for personalized AI guidance and user data collection.

In another embodiment, data training is performed based on user experiences and further includes sentimental analysis information.

In another embodiment, the system further comprises a plurality of connected information nodes positioned around an indoor space.

In another embodiment, the system provides personalized navigation with optimal path determination based on the type of disability of the user.

In another embodiment, the system is customized based on the type of disability of the user, and is capable of adapting to multiple disabilities.

In another embodiment, the system further comprises a control device and an optimal path navigation module, wherein the optimal path navigation module is configured to obtain a destination information from the user, obtain a digital map based on the destination information, generate a path by applying an Artificial Intelligence (AI) model, present the path to the user in a format depending on the generated user interface, perform navigation for the user towards the destination by applying the AI model for assisting with the navigation guidance, obtain user feedback and input the user feedback into the AI model for future navigation, wherein the AI model is trained by a supervised machine learning system and an unsupervised machine learning system independently and simultaneously.

In another embodiment, the system further comprises a non-transitory computer readable storage medium for storing a program causing one or more processors to perform a method for Artificial Intelligence (AI)-assisted navigation in an indoor space for a user with single or multiple disabilities.

In another embodiment, pre-defined paths, maps and user information are stored within a database.

As another aspect of the present invention, a method for providing indoor navigation to a user with disabilities is disclosed, the method comprising obtaining a user input data, generating and then activating a user interface type based on the user input data, determining a destination information, generating a path by applying an Artificial Intelligence (AI) model and presenting the path to the user in a format depending on the activated user interface type, wherein the indoor navigation is customized based on a type of disability of the user.

In an embodiment of the present invention, the user interface type is a graphic user interface, voice user interface, and a combination of Adaptive User Interface text and voice-based interface.

In another embodiment, the method for providing indoor navigation is interactive and capable of generating a feedback for requesting real-time physical assistance to the user.

In an embodiment, the indoor navigation functions based on artificial Intelligence (AI) and Augmented Reality (AR) technologies.

In an embodiment, the user is provided guidance or navigation control through Global Positioning System (GPS) and/or multiple information-nodes for indoor positioning system.

In an embodiment, an Indoor Web Facility Manager Application is used for real-time path planning.

In an embodiment, crowds and incidents are tracked for the real-time path planning.

In an embodiment, the Indoor Web Facility Manager application further comprises an Information Management module that triggers important alerts and notifications on a user's control device in case of emergency or urgent announcement.

In an embodiment, the system is operable online or offline.

In an embodiment, preplanning of a journey is conducted using pre-defined paths stored in a random access memory (RAM) of a device on which the indoor navigation system is running.

In an embodiment, real-time sentiment and personality analysis is conducted for personalized AI guidance and user data collection.

In an embodiment, data training is performed based on user experiences and further includes sentimental analysis information.

In an embodiment, the system further comprises a plurality of connected information nodes positioned around an indoor space.

In an embodiment, the system provides personalized navigation with optimal path determination based on the type of disability of the user.

In an embodiment, the method further comprises the steps of obtaining a destination information from the user, obtaining a digital map based on the destination information, generating a path by applying an Artificial Intelligence (AI) model, presenting the generated path to the user in a format depending on the generated user interface, performing navigation for the user towards the destination by applying the AI model for assisting with the navigation guidance; and obtaining user feedback and input the user feedback into the AI model for future navigation, wherein the AI model is trained by a supervised machine learning system and an unsupervised machine learning system independently and simultaneously.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which—

FIG. 1 is a pixel-based map showcasing two different examples of optimal paths for users with multiple disabilities using information nodes.

FIG. 2 is a diagram briefly illustrating a continuous navigation process of a user from a start point to a destination point with multiple indoor stopovers across multiple indoor geographies.

FIG. 3A show user interfaces selecting the desired destination location and FIG. 3B shows user interfaces preplanning of journey from home before reaching the location wherein predefined paths are saved in RAM (Random Access Memory) and cloud.

FIG. 4 is a block diagram briefly illustrating the processes of an Artificial Intelligence (AI) model.

FIG. 5 is a diagram illustrating a web facility manager application module.

FIGS. 6A-6C are flowcharts provided to explain an AI-assisted indoor navigation method according to an embodiment of the present disclosure.

FIG. 7 is a block diagram illustrating internal structure of an AI-assisted indoor navigation system in detail according to an embodiment of the present disclosure.

### DETAILED DESCRIPTION OF THE INVENTION

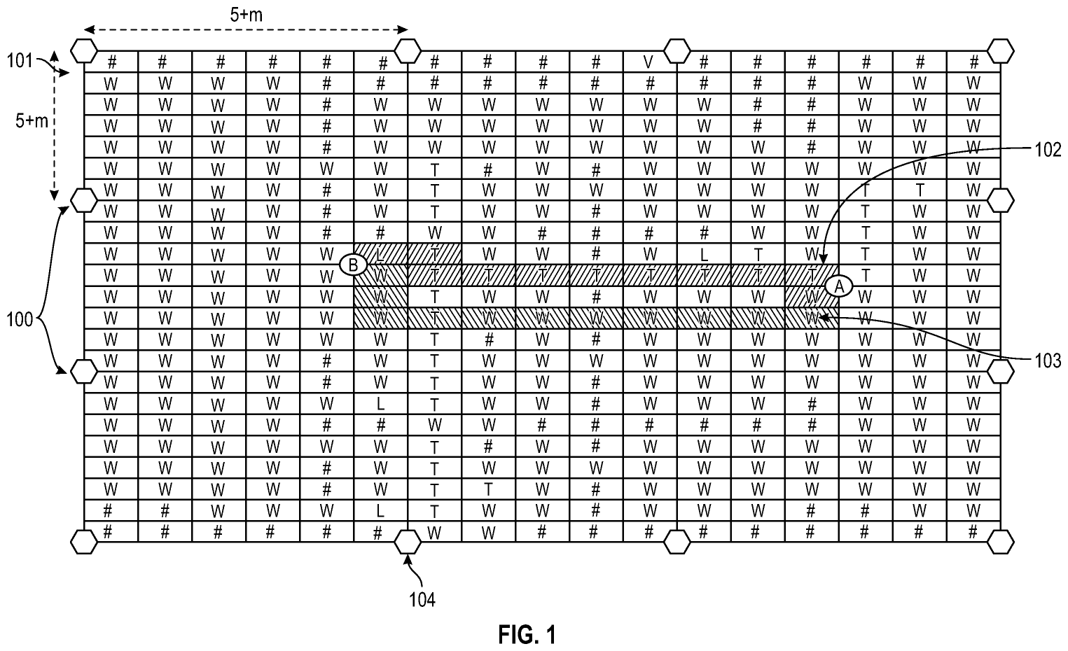

The aspects of an intelligent indoor navigation system with an adaptive user interface will be described in conjunction with FIGS. 1-7. In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

The present invention relates to a field of an interactive and mobile aid application for people challenged with multiple disabilities like deaf, mute, visually impairment, blind, autistic, cerebral palsy and other cognitive disorders. A personalized navigation guidance for people with multiple disabilities including cognitive, visual impairment, blindness, auditory and other physical disabilities includes real-time positioning and indoor path-planning when online or offline.

In a preferable embodiment of the present invention, the indoor navigation system includes an Adaptive User Interface, Graphic User Interface and a Voice User Interface. Interactive Artificial Intelligence (AI) based navigation guidance is available for people with multiple disabilities to guide and navigate the user through multiple indoor locations. Another feature includes preplanning of a journey from home even before reaching the location.

In another embodiment, real-time access to transportation data (like: Train schedules, Bus schedules, Event, Weather) for accurate journey and path planning is included along with sharing of the journey with contacts to follow a similar navigation guidance, connecting various indoor locations across different geographies using a unified communication path and real-time sentiment and personality analysis for personalized AI guidance and user feedback collection within an indoor environment. Further, a web facility manager application tracks crowds for real-time path planning and immediate assistance with a feedback mechanism to constantly enhance user experience and personalize the user's journey.

FIG. 1 depicts a personalized navigation guidance for people with cognitive, visual impairment, blindness, auditory and other physical disabilities. A pixel-based map is created based on the blueprint of the indoor environment along with information nodes. Each pixel is assigned an integer. Negative integers represent an obstacle, and positive integers represent a possible path. The lower the integer is, more optimal for people with determination. A* search algorithm is utilized to calculate the optimal path based on the user's preference. An Artificial Intelligence (AI) model is trained overtime to personalize the journey based on user preference. Once the guidance is personalized, an AUI (Adaptive User Interface) is triggered based on a user's disabilities like vision, mobility, cognitive and auditory.

In an embodiment of the present invention, people with multiple disabilities require an intelligent two-way interaction where feedback is received and processed to provide personalized real-time guidance. The navigation system in accordance with the present invention includes orienting oneself, knowing one's destination, following the best route, recognizing one's destination and finding one's way back out. People who are disabled with auditory, cognitive and/or visual impairments benefit from tactile information and require an interactive adaptive interface to facilitate wayfinding.

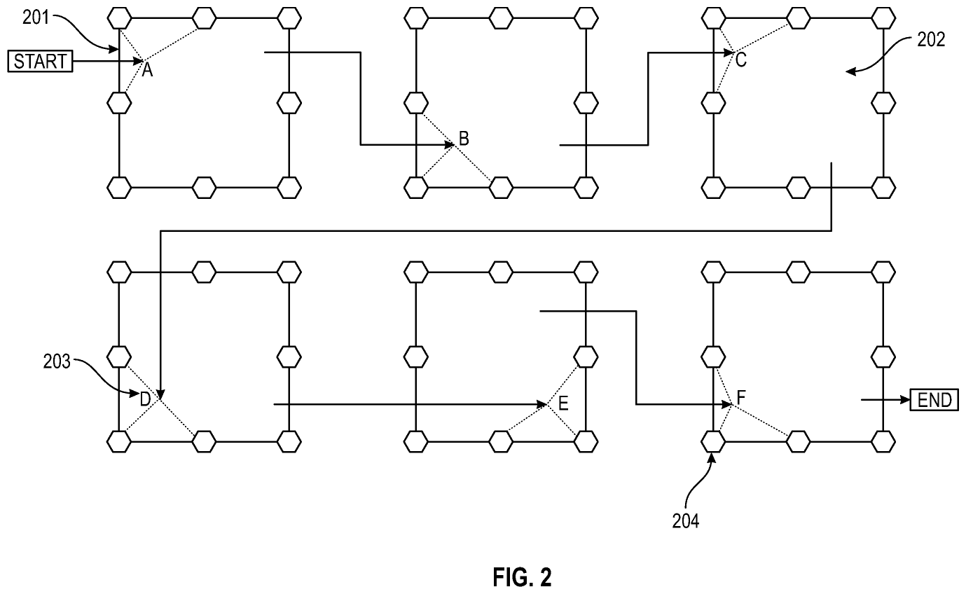

FIG. 2 depicts an interactive AI-based navigation guidance for people with multiple disabilities to guide and navigate the user through multiple indoor locations, providing a continuous navigation of multiple indoor locations. Nearby information nodes detect the current location, and it updates the user's location by re-calibrating the GPS and compass values. Input nodes layer links and parses user data to hidden nodes layer, then activation function triggers the voice-enhanced AI experience (with text-to-speech and speech-to-text) to verbally communicate with the user device. When tested with users of different or multiple disabilities like: cognitive, visual impairment, blindness, auditory and physical disabilities, interactive guidance was found to be comforting and reassuring enabling smooth travel experience within multiple unknown indoor locations.

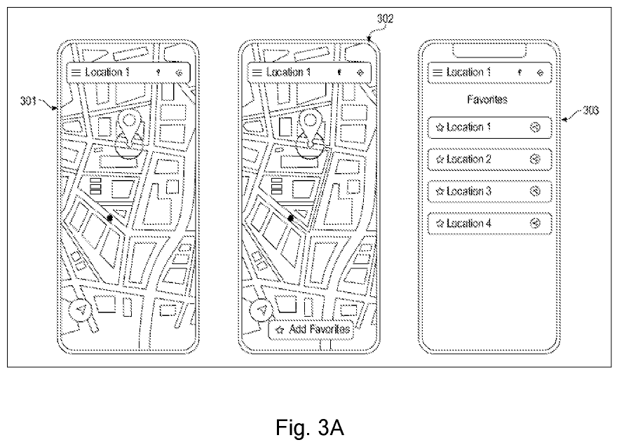

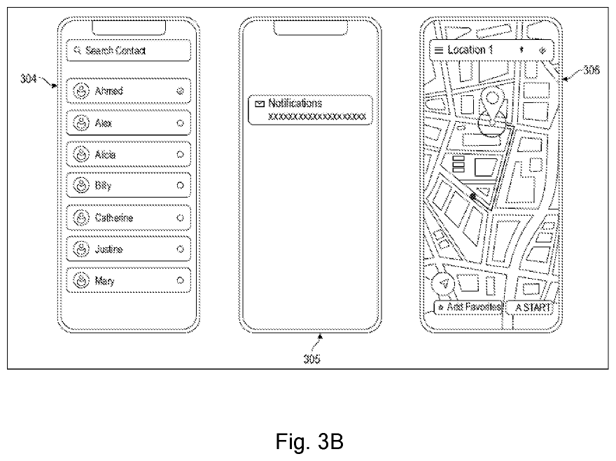

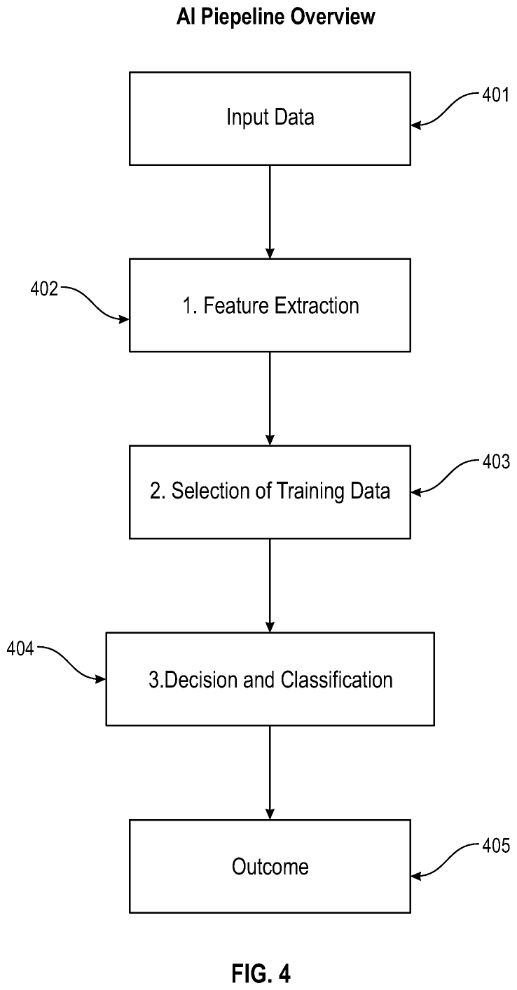

FIG. 3A show user interfaces selecting the desired destination location and FIG. 3B shows user interfaces preplanning of journey from home before reaching the location wherein predefined paths are saved in RAM (Random Access Memory) and cloud; this can be downloaded and accessed offline. The user can download these maps before staring the journey from home. In case of users with multiple disabilities the pre-downloadable guidance and simulation helps build confidence and enables the user to independently navigate when using the guidance in an actual scenario. FIG. 4 is an algorithm showing real-time sentiment and personality analysis for personalized AI guidance and user feedback collection. The algorithm runs three fundamental processes to achieve its purpose. It requires a user to provide a set of input data, then parse it to provide customized feedback. Then, it performs the features extraction (extracts critical information within user data such as navigation paths, destination input, verbal feedback, and user sentiment), then defines groups of features. Decision and classification are conducted by implementing an optimal path calculation approach that is effective in case of large number of training examples.

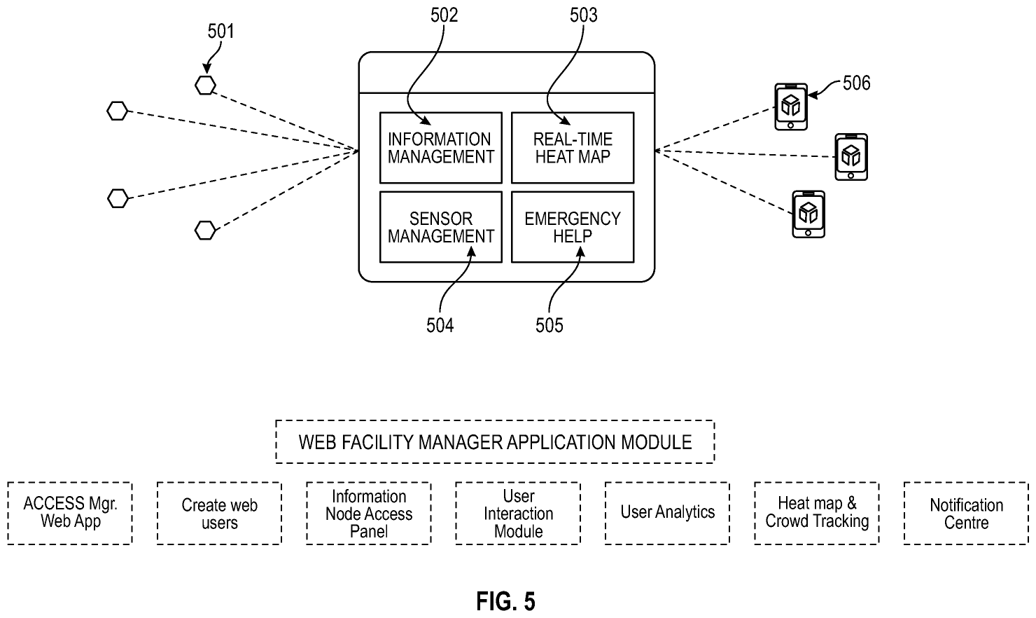

FIG. 5 shows the indoor Web Facility Manager Application to track crowds for real-time path planning and immediate assistance. The web manager application uses server, and its database is hosted locally on a server. This manager application has full control over user information and permission.

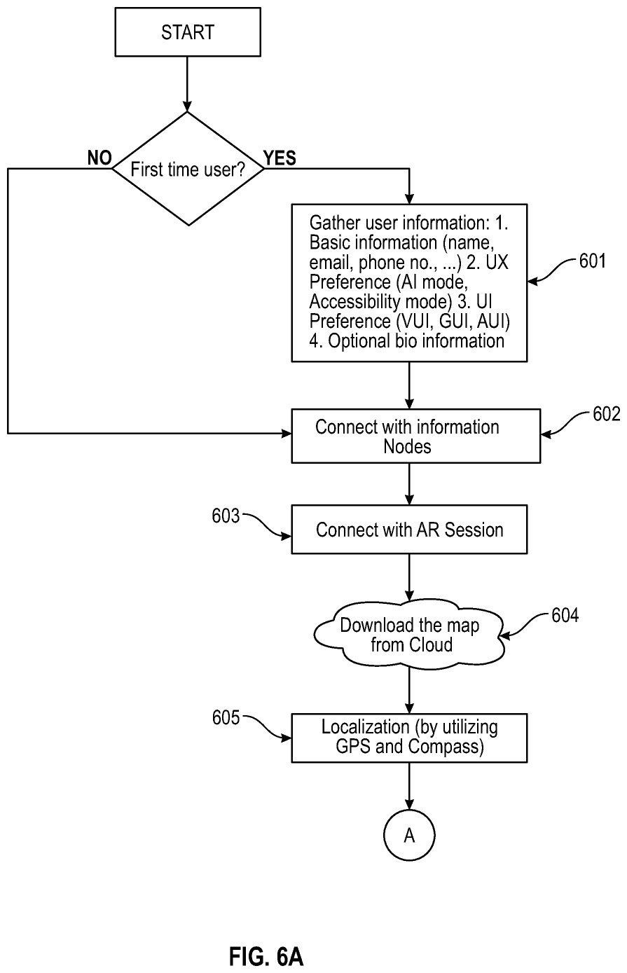

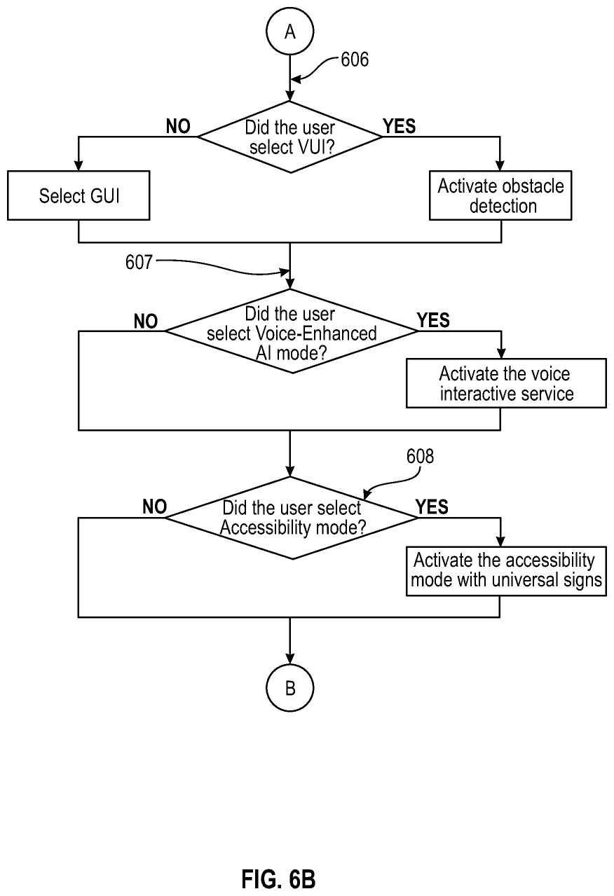

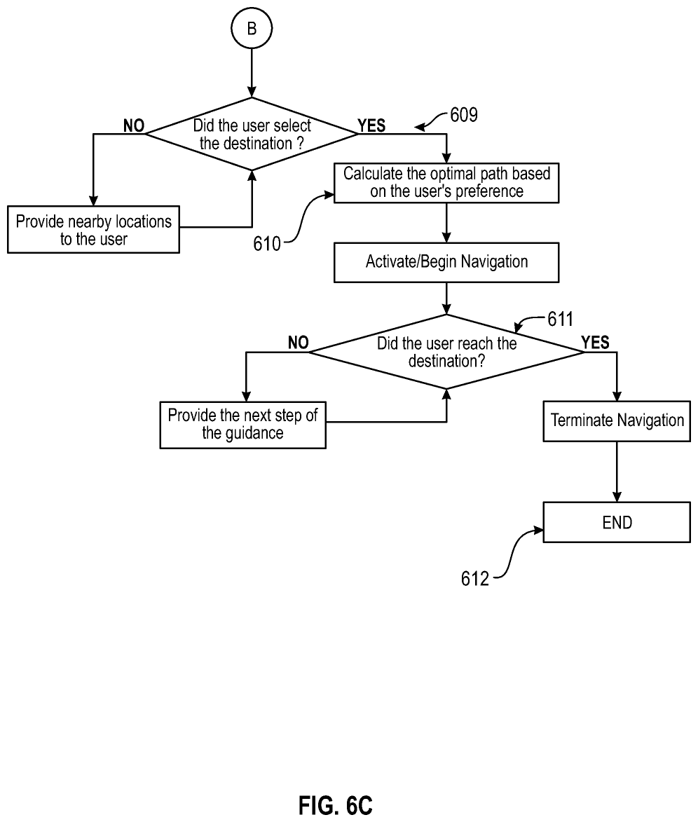

FIG. 6 A-C are flowcharts depicting a complete flow of the user-experience throughout the aided indoor navigation experience. The framework in FIG. 6A collects user information to personalize the navigation experiences like disability profile, user interface preference (VUI, GUI, AUI), and optional biological profile information to render a fully customized experience on a real-time basis. The profile is stored in the database and is progressively updated as the user interacts with the navigation framework. The journey is connected to the AR session and accesses the map based on the user's indoor destination choice. The map is linked to offline and online information points to ensure seamless user experience.

Based on user's selection of VUI, GUI or AUI, guidance is activated to navigate the user via the most optimal path leading to the destination. Obstacle detection—both moving and non-moving is tracked to ensure user's safety, as depicted in FIG. 6B. Universal design approach is embedded in the VUI (Voice User Interface), GUI (Graphic User Interface) and AUI (Adaptive User Interface). In FIG. 6C, the user selects a destination prior to starting the journey. In case user does not select the indoor destination; user is prompted to select from nearby locations to provide guidance and assistance. If the user does not follow the guidance to reach the indoor destination, the guidance is recalibrated to assist the user reach the destination or notification is sent to the facility manager to provide assistance in case of emergency. When tested with users with disabilities, the solution was welcomed and found very helpful especially in case of larger indoor premises that require users to navigate longer paths to reach their destination.

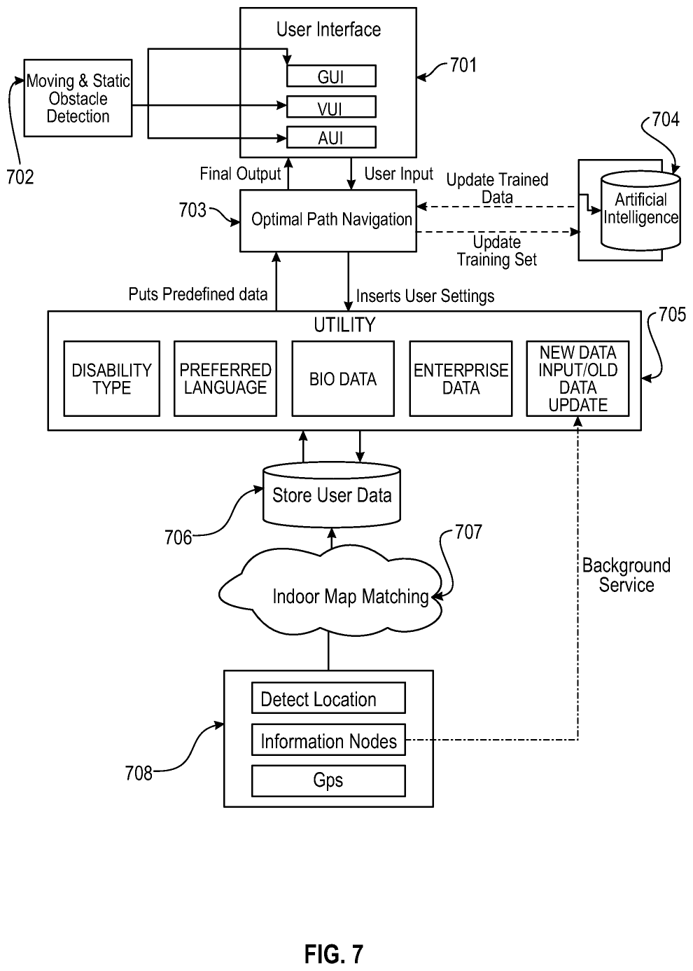

FIG. 7 represents an integrated user-experience across different technologies and information nodes to create a fully synchronized and personalized indoor navigation guidance. The method supports user to select either Graphical User Interface (GUI), Voice User Interface (VUI), and Adaptive User Interface (AUI) to run the most efficient interface based on the user's profile. In addition, it provides an option to add static and moving obstacle detection along with the primary user interface.

Once the user input is finalized, it calculates the optimal path from the selected starting point to the destination. This optimal path result differs per user as it is directly connected with the utilities that customize the navigation. The utilities include user's disability type, preferred language, biological data, and enterprise data; all information is stored in both RAM and cloud server. Finally, all the data is transferred to the user's control device when the nearby information node is detected. The information node triggers and pulls user and navigation information.

FIG. 1 is a personalized navigation guidance for those with cognitive, visual impairment, blindness, auditory and other physical disabilities. To deliver a personalized user experience to users with one or multiple disabilities, an algorithm has been designed to customize or personalize the logic for each type of disability. 101 demonstrates the minimum distance between the information nodes (5 meters) to ensure most accurate calculation and guidance. This has been concluded after conducting several rounds of tests within different types of indoor environments (aboveground, at various levels and under-ground).

In an embodiment, weightage is given to the paths based on obstacles found, tactile paving footpath, defined paths and lift (elevator) to calculate the most optimal path. For example, in FIG. 1 the ‘#’ represents the presence of an obstacle (Obstacle) and is given weight=−1, ‘W’ indicates the presence of a defined path (Way) and is given weight=100, ‘T’ is indicative of the presence of a tactile path (Tactile) and is given weight=50, and ‘L’ indicates the presence of a lift or elevator (Lift) and is given weight=10. The weights are taken into consideration for compilation as part of the AI algorithm for determining the optimal path as a function of the user's disability. In this example, paths 102 and 103 are generated as optimal paths based on the compilation conducted by the AI Algorithm. Path 102 represents the optimal path determined by the AI Algorithm for users with visual impairment or blindness whereas Path 103 represents the optimal path determined by the AI Algorithm for users with mobility impairment. A formula utilized for calculation of the weights is dynamic and is determined using the AI algorithm on a real-time basis.

In the present disclosure, the control device can be a mobile device such as a smartphone, a tablet, an e-reader, a PDA or a portable music player.

Within the indoor space, a plurality of information nodes are arranged. In FIG. 1, the location of the information nodes are marked as 100. In FIG. 1, reference numeral 101 demonstrates a minimum distance between information nodes. In this embodiment the minimum distance between two information nodes is 5 meters. The information nodes are arranged in an indoor space and connected or configured to be connected with a control device of the user to ensure an accurate calculation and determination of an optimal path and navigation guidance between the user location and destination. This minimum distance has been determined as an optimal distance between the nodes based on several rounds of tests conducted within different types of indoor environments, e.g. above ground, at various levels and under-ground.

A weightage is given respectively to each path among the various paths available between the user location and the destination required based on a number of criteria comprising presence or absence of obstacles detected within the path, presence or absence of a tactile paving footpath within the path, presence or absence of a defined path and presence or absence of a lift (elevator) within the path. The path weightage is taken into consideration to determine the most optimal path between the user location and the user destination as a function of the specific disability of the user. The optimal path for a user having a given type of disability (for example blindness) may be different from the optimal path for a user having another type of disability (for example mobility impairment).

The entire journey map is configured in the user's control device upon selection of destination and based on real-time incidents/scenario and dynamic changes on the user's path, the map is calculated on a real-time basis to provide guidance in the VUI, GUI or AUI format based on user preference. This is achieved through the dynamic map generated via the AR (Augmented Reality) module that relays information to the main algorithm that determines the final guidance output for the user. AI (Artificial Intelligence) module is trained over time by the user to fully personalize the user experience through the control device based on preferences and usage pattern. When tested with users in a real scenario, the navigation guidance resulted in the most accurate and optimal path planning even in the case of changing map due to crowds or unplanned/sudden indoor floor plan modifications.

102 and 103 illustrate two of the various paths that can be created for people with disabilities like: blindness, visual impairment and mobility. Similar calculations are run for those with cognitive disabilities like mobility, ASD, etc. and those with auditory disabilities, cerebral palsy and multiple combinations of disabilities. 104 represents the obstacles both moving and non-moving that are detected through user's control device by scanning the surrounding indoor environment using real-time image processing. These obstacles (both moving and non-moving) are detected on a real-time basis to ensure users' safety while travelling.

An entire journey map is configured in the user's control device upon selection of a destination and based on real-time incidents/scenario and dynamic changes on the user's path. An optimal path is calculated on a real-time basis to provide guidance in the Voice User Interface (VUI), Graphic User Interface (GUI) or Adaptive User Interface (AUI) format based on user data and preference. This is achieved through the dynamic map generated via the Augmented Reality (AR) module that relays information to the main algorithm that determines the final guidance output for the user.

The navigation system and method of the present disclosure, which will be described later, are assisted by utilizing an Artificial Intelligence (AI) model. The AI model is trained over time by the user to fully personalize the user experience through the control device based on user's preferences and usage pattern. When tested with users in a real scenario, the navigation guidance resulted in the most accurate and optimal path planning even in the case of changing map due to crowds or unplanned/sudden indoor floor plan modifications.

Referring to FIGS. 1, 102 and 103 illustrate two of the various paths that can be created for people with disabilities such as blindness, visual impairment and mobility. Similar calculations are run for people with cognitive disabilities like mobility, ASD, etc. and people with auditory disabilities, cerebral palsy and multiple combinations of disabilities. The reference numeral 104 represents both moving obstacles and static non-moving obstacles.

FIG. 2 is an interactive AI-based navigation guidance for people with multiple disabilities to guide and navigate the user through multiple indoor locations. 201 indicates the starting point of the user's journey where there are multiple indoor locations as stopovers on the path. At the time of starting the journey, user selects the final destination and preferred travel path. The information nodes then connect the user's navigation guidance within the indoor path. This guidance is triggered through a voice, graphic or adaptive user interface based on user preference. Depicted as 202, once the user navigates through one indoor environment, the user is guided to the next location on the selected path via the information nodes. During this process the AR navigation remains active along with image processing to alert the user on obstacle (moving and non-moving) detection through the control device.

User also has the ability to provide feedback about the experience of the completed journey. The experience can be stored in a cloud server and marked as favorite and shared with contact person of the user. The Artificial Intelligence model learns and trains with user data and provides customized user experience at every instance of usage of the control device by the user. According to the embodiment of the present disclosure, real-time sentiment and personality analysis for a personalized AI guidance and user feedback collection are achieved. To achieve this purpose and based on the above introduced algorithm and fundamental processes according to FIG. 4, the AI model according to the present disclosure has been trained by two independent machine learning systems which are performed simultaneously.

One of the machine learning systems for training the AI model is a supervised machine learning system for sentiment analysis. For example, voice feedback of the user can be obtained and processed into a text file by utilizing speech to text function. The text file of the user feedback is gathered as input of the supervised machine learning system. Output is a list of sentiment types, e.g. happy, worried, sad etc. A learning algorithm is run based on the gathered training set. The other one of the machine learning systems for training the AI model is an unsupervised machine learning for optimal path enhancement. For example, the input is a new pixel map file obtained from the completed path of the user. A training model runs through the user pixel map files. The neural network is not provided with desired outputs. The system itself must then decide what features it will use to group the input data.

The above introduced machine learning systems are independent and are performed simultaneously. By applying two independent machine learning systems simultaneously, the AI training can be enriched that lead to continuously improving users experience.

In an embodiment, the user is assured when following the correct path and guided in case of deviation from the selected path, if the user is lost, a recalibrated path is suggested but if the user is unable to follow the guidance, the indoor facility manager is notified to provide on-ground assistance through any of the preferred mode of communication (VUI, GUI or AUI). The user can also call for assistance at any given point in time. This alert for help is linked to the Web Indoor Facility Manager Application described in FIG. 5.

The indoor navigation is tracked across multiple indoor locations on the user's path across multiple indoor geographies. In the previous disclosed U.S. Pat. No. 10,302,757 B2 by an Italian company, the aided guidance for the visually impaired was limited to one indoor location whereas in the present invention, the user is successfully able to navigate across multiple indoor locations spread across different geographies. Each indoor journey undertaken by the user is tracked & recorded for future reference. Alerts are sent in the preferred format—VUI (Visual User Interface), GUI (Graphic User Interface) or AUI (Adaptive User Interface) based on user's selected method of communication. UI can be changed by the user at any time based on the preference or journey-type.

User GPS and compass values are passed through the information framework in alignment with the triggers from the information node to present the user with the most accurate navigation information and guidance based on user's real-time position and location. This information is delivered using Artificial Intelligence (AI) through graphic, voice or adaptive user interface modes. As shown as 204, the user upon arrival at the final destination is alerted and guided to exit the indoor premise. The user feedback is collected at this stage to constantly enhance and personalize the navigation guidance.

FIGS. 3A and 3B shows preplanning of journey from home before reaching the location wherein 301 shows predefined paths are saved in RAM (Random Access Memory) and cloud; this can be downloaded and accessed offline. User provides destination input and a map is presented based on defined routes configured within the application framework. Customized map can also be created by the user by adding stopover points within the indoor journey. These maps are stored on cloud and are linked to the user's profile for future reference. In 302, the user may download these maps before staring the journey from home. In case of users with multiple disabilities the pre-downloadable guidance and simulation helps build confidence and enables the user to independently navigate when using the guidance in an actual scenario.

Further, multiple locations, paths or maps can be saved as favorites by the user for future reference. User can also share this maps or favorited locations with contacts on the user's phonebook, or manually input a contact. Users with similar disabilities can also view suggested maps, routes and navigation guidance for their reference. When the user shares the map with a phonebook contact a notification is sent to the contact on their control device (305). In 306, the recipient can then access the notification to access and activate (start using) the map. The map can be stored with the data of the recipient's profile information on the control device. The user can delete this information if the user doesn't want the application to record this data. User can also share the route, map and/or navigation guidance with other phonebook contacts, or manually input a contact. The Artificial Intelligence algorithm learns and trains with user data and provides customized user experience at every instance of usage of the control device by the user.

In FIG. 4, real-time sentiment and personality analysis for personalized AI guidance and user feedback collection is shown. Upon receiving the input from the user in the form of a request or command via the VUI (Visual User Interface), GUI (Graphic User Interface) or AUI (Adaptive User Interface), the algorithm runs three fundamental processes to achieve its purpose and deliver an accurate outcome (401). Feature Extraction function involves extracting critical information within user data such as navigation paths, verbal feedback, points of interests within the indoor facilities and nearby indoor locations based on user input. The data is stored in cloud and is also relayed as per the algorithms that run on a real-time basis to deliver the most accurate output. The Feature Extraction function is also relative to the live scenario around the user which is tracked and relayed back to the core algorithm using Augmented Reality (AR) facility. The groups of features are defined by this function that relates to the user requirements and input provided to activate the navigation (402).

Selection of Training data is based on previously recorded instances, data sets, navigation paths, sentiment of the conversations, etc. to provide a personalized AI (Artificial Intelligence) guidance to the user on a real-time basis. This guidance is a two-way communication that allows the user to have a conversation with the navigation platform for instructions, feedback and specific assistance (403). Decision and classification are conducted by implementing an optimal path based on a calculation approach that is effective in case of large number of training examples that are stored within the framework. These examples are classified by user preference types, journey types and disabilities to render optimal paths and calculations when the input is parsed and delivered via the Artificial Intelligence (AI), Augmented Reality (AR), Global Positioning System (GPS) data (404).

Outcome is delivered in the desired User Interface (UI)—VUI (Visual User Interface), GUI (Graphic User Interface) or AUI (Adaptive User Interface) based on user selection and preference. User also has the ability to provide feedback about the experience. The experience can be stored (FIG. 3), marked as favorite and shared with contacts of the user (405).

FIG. 5 depicts the indoor Web Facility Manager Application to track crowds for real-time path planning and immediate assistance. Information Nodes can be tracked and managed through the Indoor Web Facility Manager application. The web manager application uses server, and its database is hosted locally on a server. This manager application has full control over user information and permission (501). The Information Nodes are linked to the Information Management module that triggers important alerts and notifications on the user's control device in case of emergency or urgent announcement. The asset tracker within the Information Management module tracks working of the Information Nodes placed across the indoor premise (502).

Real-time heat maps are generated to track active users and communicate with them when necessary. This allows the Indoor Web Facility Manager to take important or critical actions to assist people with disabilities during their indoor navigation journey. Crowd management by altering the navigation paths can be managed on a real-time basis to ensure an uninterrupted indoor navigation guidance (503). Information Node sensor manager enables the user Indoor Web Facility Manager to track the Information Node sensors located across the indoor premise. It tracks if the Information Nodes are fully or partially functional and placed at the correct positions within the indoor floor plan (504).

Emergency Help function connects the user's control device to the Indoor Web Facility Manager's application view by relaying messages in case user needs urgent assistance. This also allows the Indoor Web Facility Manager application to send messages to troubleshoot within the given situation and also guide the user to the nearest safe point where assistance can be made available (505). Control Device communication is linked to the Indoor Web Facility Manager's application for instant and real-time communication. Real-time communication is AI (Artificial Intelligence) driven to provide immediate and relevant voice, text or graphic-based assistance to the user to till manual assistance is provided (if required). In case, the AI (Artificial Intelligence) guidance is able to resolve and troubleshoot, Indoor Web Facility Manager is notified (506).

FIG. 6A depicts a complete flow of the user-experience throughout the aided indoor navigation guidance. The framework collects user information to personalize the navigation guidance including disability profile, user interface preference VUI (Voice User Interface), GUI (Graphic User Interface) and AUI (Adaptive User Interface) and optional biological profile information to render a fully customized experience on a real-time basis. This information trains the Artificial Intelligence module overtime to classify the training data and augment the decision process (FIGS. 4-403,404). The user profile is then synchronized with the Information Nodes to establish a data flow and relay triggers on a real-time basis. These information nodes are capable of communication even without a Wi-Fi or internet connection using the control devices' Bluetooth connection. Hence, the map is available in both online and offline formats (602).

Connecting with the Augmented Reality (AR) session. Once the Information Nodes are connected, they are linked to the Augmented Reality (AR) session to ensure real-time map simulation on the control device and to better scan the user's environment. In addition, it also monitors moving or non-moving obstacles and alert the user in case of a crowd that is likely to clog the user's path to the selected destination (603). Then, the map of the selected destination is downloaded from cloud onto user's control device and then real-time data from Information Nodes and Augmented Reality (AR) is intertwined to provide an integrated, optimized, personalized and intelligent navigation guidance. The data is validated and referenced back with the Global Positioning System (GPS) and Compass data from the user's control device to ensure highest level of accuracy and error-free navigation guidance.

FIG. 6B shows a complete flow of the user-experience throughout the aided indoor navigation guidance. The Decision Process based on the data input received from the user and preference selected at the beginning of a journey—at this stage the algorithm records the user preference VUI (Voice User Interface), or GUI (Graphic User Interface). In case of returning users, this preference is stored for consecutive usage. Obstacle detection is activated based on the preferred mode of user interface selected by the user (606). Decision stage whereby user selects Artificial Intelligence driven User Interface or AUI (Adaptive User Interface), subsequent features are extracted and rendered through a conversational Artificial Intelligence based framework (607). When a user selects the Accessibility Mode, user is provided with universal guidance via speech and graphics using symbols and guidance in compliance with the international standards of communication with people with disabilities (608).

FIG. 6C is a complete flow of the user-experience throughout the aided indoor navigation guidance. User selects a destination prior to starting the indoor guidance. In case user does not select the indoor destination; user is prompted to select from nearby indoor locations to provide guidance and assistance. If the user doesn't follow the guidance to reach the indoor destination, the guidance is recalibrated to assist the user reach the destination or notification is sent to the facility manager to provide assistance in case of emergency (609). Optimal paths are calculated based on user preference and disability type (FIG. 1) and navigation is activated upon user's consent using the control devices. User's path is tracked at every step and any deviation from the selected or defined paths notify the user and recalibrate the map to help the user reach the destination using the shortest and the most optimal path (610).

At every stage of the completion of the journey within the user's path, a notification is sent assuring the user that the path is correctly being followed until the user reaches the final destination based on the prior selection submitted by the user (611). Once the journey is successfully completed the user is prompted to select the next destination or terminate the navigation guidance (612).

In FIG. 7 displays an integrated user-experience across different technologies and information nodes to create a fully synchronized and personalized indoor navigation guidance. The method supports user to select either Graphical User Interface (GUI), Voice User Interface (VUI), and Adaptive User Interface (AUI) to run the most efficient interface based on the user's profile entered and disability typed stated by the user (701). In addition, it provides an option to add static and moving obstacle detection along with the primary user interface. This is alerted in the form of voice, text and haptic signals to notify the user (702).

Once the user input is finalized, it calculates the optimal path from the selected starting point to the destination. (Refer FIG. 1) The Artificial Intelligence module trains using user data captured during the profiling stage, interactions and conversations with the control device (704). This optimal path result differs per user as it is directly connected with the utilities that customize the navigation. The utilities include user's disability type, preferred language, biological data, enterprise data, etc.; 706 all information is stored in both RAM and cloud server (705).

Indoor map matching process is carried out on the cloud platform based on the destination input by the user and connects with the Information Node and Augmented Reality (AR) session to trigger real-time guidance (707). Finally, all the data is transferred to the user's control device when the nearby information node is detected. The information node triggers and pulls user and navigation information (708).

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims which follow.

1. An adaptive indoor navigation system for users with single or multiple disabilities comprising an adaptive user interface having a plurality of guidance modes,
wherein a particular guidance mode is activated based on selection of a type of user interface by a user of the adaptive indoor navigation system, and
wherein the adaptive indoor navigation system is customized based on a type of the disability.

2. The adaptive indoor navigation system of claim 1, wherein the plurality of guidance modes comprises a text-based guidance mode, voice-based guidance mode and an adaptive user interface which is a combination of text and voice based guidance mode.

3. The adaptive indoor navigation system of claim 1, wherein the adaptive indoor navigation system functions based on Artificial Intelligence (AI) and Augmented Reality (AR) technologies.

4. The adaptive indoor navigation system of claim 1, wherein the user is provided guidance or navigation control through Global Positioning System (GPS) or a multiple-node indoor positioning system.

5. The adaptive indoor navigation system of claim 1, wherein an Indoor Web Facility Manager Application is used for real-time path planning.

6. The adaptive indoor navigation system of claim 1, wherein crowds and incidents are tracked for the real-time path planning and wherein the system is operable online or offline.

7. The adaptive indoor navigation system of claim 5, wherein the Indoor Web Facility Manager application further comprises an Information Management module that triggers important alerts and notifications on a user's control device in case of emergency or urgent announcement.

8. The adaptive indoor navigation system of claim 1, wherein preplanning of a journey is conducted using pre-defined paths stored in a random access memory (RAM) of a device on which the indoor navigation system is running.

9. The adaptive indoor navigation system of claim 1, wherein real time sentiment and personality analysis is conducted for personalized AI guidance and user data collection.

10. The adaptive indoor navigation system of claim 1, wherein data training is performed based on user experiences and further includes sentimental analysis information.

11. The adaptive indoor navigation system of claim 1, wherein the system further comprises a plurality of connected information nodes positioned around an indoor space.

12. The adaptive indoor navigation system of claim 1, wherein the system provides personalized navigation with optimal path determination based on the type of disability of the user.

13. The adaptive indoor navigation system of claim 1, wherein the system is customized based on the type of disability of the user, and is capable of adapting to multiple disabilities.

14. The adaptive indoor navigation system of claim 1, further comprising a control device and an optimal path navigation module, wherein the optimal path navigation module is configured to:
obtain a destination information from the user;
obtain a digital map based on the destination information;
generate a path by applying an Artificial Intelligence (AI) model;
present the path to the user in a format depending on the generated user interface;
perform navigation for the user towards the destination by applying the AI model for assisting with the navigation guidance;
obtain user feedback and input the user feedback into the AI model for future navigation, wherein the indoor navigation is customized based on real-time needs of the user, and the AI model is trained by a supervised machine learning system and an unsupervised machine learning system independently and simultaneously.

15. The adaptive indoor navigation system of claim 14, wherein the system further comprises a non-transitory computer readable storage medium for storing a program causing one or more processors to perform a method for Artificial Intelligence (AI)-assisted navigation in an indoor space for a user with single or multiple disabilities.

16. The adaptive indoor navigation system of claim 14, wherein pre-defined paths, maps and user information are stored within a database.

17. A method for providing indoor navigation to a user with disabilities, the method comprising:
obtaining a user input data;
generating and activating a user interface type based on the user input data;
determining a destination information;
generating a path by applying an Artificial Intelligence (AI) model; and
presenting the path to the user in a format depending on the activated user interface type, wherein the indoor navigation is customized based on a type of disability of the user.

18. The method of claim 17, wherein the user interface type is a graphic user interface, voice user interface, and a combination of Adaptive User Interface text and voice-based interface.

19. The method of claim 17, wherein the method for providing indoor navigation is interactive and capable of generating a feedback for requesting real-time physical assistance to the user.

20. The method of claim 17, further comprising the steps of:
obtaining a destination information from the user;
obtaining a digital map based on the destination information;
generating a path by applying an Artificial Intelligence (AI) model;
presenting the generated path to the user in a format depending on the generated user interface;
performing navigation for the user towards the destination by applying the AI model for assisting with the navigation guidance; and
obtain user feedback and input the user feedback into the AI model for future navigation, wherein the indoor navigation is customized based on real-time needs of the user, and the AI model is trained by a supervised machine learning system and an unsupervised machine learning system independently and simultaneously.
